(19) United States
(12) Patent Application Publication
(10) Pub. No.: US 2008/0117920 A1
(43) Pub. Date: May 22, 2008

(54) Content Harvesting and Harmonizing Gateway

(75) Inventor: Brian J. Tucker, Mesa, AZ (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/561,588

(22) Filed: Nov. 20, 2006

(51) Int. Cl. H04L 12/66

(52) U.S. Cl. 370/401

(57) ABSTRACT

Described herein are embodiments that provide a gateway device dedicated for harvesting content from a content service and harmonizing the content in a content player with the harvested content. Thus, the dedicated gateway device provides a practical, low-cost gateway for downloading desired content wherever a network connection to the content service is available and without the need for the re-installation of a gateway application at each desired new location for content harvesting and harmonization.

### RELATED APPLICATIONS

This application is related to and incorporates by reference in their entireties the following U.S. Utility Patent Applications all of which are assigned to the assignee of the present application: U.S. patent application Ser. No. 11/296,975, filed Dec. 8, 2005, and entitled, “WIRELESS ADAPTOR FOR CONTENT TRANSFER” (Attorney Docket No. BCS03802); U.S. patent application Ser. No. 11/297,760, filed Dec. 8, 2005, and entitled, “WIRELESS ADAPTOR FOR CONTENT TRANSFER” (Attorney Docket No. BCS03803); U.S. patent application Ser. No. 11/296,971, filed Dec. 8, 2005, and entitled, “GRANTING GREATER RIGHTS TO STORED CONTENT,” (Attorney Docket No. BCS03804); U.S. patent application Ser. No. 11/296,977, filed Dec. 8, 2005, and entitled, “AUTOMATIC CONTENT UPDATE FOR A TARGET DEVICE” (Attorney Docket No. BCS03805); and U.S. patent application Ser. No. 11/296,990, filed Dec. 8, 2005, entitled, “HOT CONTENT UPDATE FOR A TARGET DEVICE” (Attorney Docket No. BCS03806); U.S. patent application Ser. No. 11/441,967, filed May 25, 2006, and entitled, “WIRELESS ADAPTOR FOR FACILITATING HANDS-FREE WIRELESS COMMUNICATION FUNCTIONALITY” (Attorney Docket No. BCS04116); and U.S. patent application Ser. No. 11/441,968, filed May 26, 2006, also entitled, “WIRELESS ADAPTOR FOR FACILITATING HANDS-FREE WIRELESS COMMUNICATION FUNCTIONALITY” (Attorney Docket No. BCS04117).

### BACKGROUND

Portable content players and other devices capable of playing content, such as media like music or videos, are becoming increasingly popular and are typically designed to play the personal content of users. Users tend to use multiple media devices, such as an MP3 digital music player, wireless or cellular phone, personal digital assistant (PDA), personal computer, and a car audio system, Many of these devices are capable as content players for playing the personal content of the users. Typically, content harvesting or downloading to content player involve the use of a personal computer (PC) that acts as a gateway for harvesting content from a content server and for harmonizing or synchronizing such content between the PC to the portable content player for playback by the latter. Consequently, the PC has installed therein a content gateway software that facilitates content harvesting from a content server and content harmonizing with the portable content player.

Content harmonization is typically accomplished through a connection between the portable content player and the gateway PC. As referred herein, content harmonization includes a synchronization of the content stored in a content player with the content cached or stored in a host device, such as the gateway PC or a content server, so that upon completion of the synchronization, the content player contains updated content provided by the content cached or stored in the host device. The typical approach to harvesting and harmonizing content for a content player has several drawbacks. First, the gateway PC requires installation therein of a specific gateway software for content harvesting from a content provider and content harmonizing with the target content player. This specific gateway software is dependent on the particular operating system (OS) of the PC in which it operates. For example, if the PC is operating in a MICROSOFT WINDOWS, LINUX, UNIX, or MAC OS environment, then the gateway software must be WINDOWS-based, LINUX-based, UNIX-based, or MAC OS-based, respectively. Thus, a user wishing to employ a PC as a gateway to harvest and harmonize content for downloading to a desired content player must have available a pricey PC, must actively identify the type of OS that the PC uses, and must install the appropriate gateway software that is specific for the identified OS. Another drawback of the gateway PC is that it does not allow usage of the content player for an extended period of time without the need to access the gateway PC for content re-harmonization. Furthermore, the user cannot use any PC for re-harmonization because: a) such a PC must have the gateway software installed therein; and b) only the original gateway PC that the user initially used to set up content harvesting and harmonization for the content player would have information about the content player and past harmonization instances to properly perform the re-harmonization.

### SUMMARY

Described herein are embodiments for a practical and low-cost gateway device between a content server (of a content provider) and a content player. The gateway device is dedicated to harvesting content from the content server and harmonizing the content player with the harvested content. Unlike a typical PC, the dedicated gateway device in accordance with various embodiments described herein is not required to be a general-computing device so as to run applications other than content harvesting and harmonization. Thus, more economical components may be used to build the dedicated gateway device. By providing power and connectivity from both the content server and the content player to the dedicated gateway device, a user is then able to connect a content player to the dedicated gateway device for charging and/or harvesting and harmonizing the content therein—all without the need for a cumbersome device such as a PC and reliance on the OS and gateway software therein.

Accordingly, in one embodiment, there is provided a gateway device dedicated for harvesting content from a content service and harmonizing the content with a content player, comprising: a first interface operable to be connected to the content service to harvest content from the content service; a first memory storage operable to store the harvested content; and a second interface operable to be connected to a content player for harmonizing with the content player so as to ensure that the stored content is available in the content player for content playback.

In another embodiment, there is provided a method for employing a dedicated gateway device to harvest and harmonize content with a content player, comprising: initializing the dedicated gateway device for harvesting content; establishing a connection between the dedicated gateway device and a content service to harvest content from the content service based on the initializing; the dedicated gateway device harvesting the content from the content service, the content is selected from the initializing; the dedicated gateway device detecting a connection with the content player; and the dedicated gateway device harmonizing with the content player to ensure that the harvested content is available in the content player for playback.

In still another embodiment, there is provided a computer readable medium on which is encoded program code for employing a dedicated gateway device to harvest and harmonize content with a content player, the program code comprising: program code for initializing the dedicated gateway device for harvesting content; program code for establishing a connection between the dedicated gateway device and a content service to harvest content from the content service based on the initializing; program code for harvesting with the dedicated gateway device the content from the content service, the content is selected from the initializing; program code for detecting with the dedicated gateway device a connection with the content player; and program code for harmonizing the dedicated gateway device with the content player to ensure that the harvested content is available in the content player for playback.

### BRIEF DESCRIPTION OF THE DRAWINGS

Embodiments are illustrated by way of example and not limited in the following figure(s), in which like numerals indicate like elements, in which:

FIG. 1 illustrates a system for content distribution, according to an embodiment;

FIG. 2 illustrates an example of the system for content distribution shown in FIG. 1, according to an embodiment;

FIG. 3 illustrates an operation environment of a dedicated gateway device, according to an embodiment;

FIG. 4 illustrates a method for using a dedicated gateway device for content harvesting and harmonization, according to an embodiment; and

FIG. 5 illustrates a method for using a dedicated gateway device for content harvesting and harmonization, according to another embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

### 1. System Overview

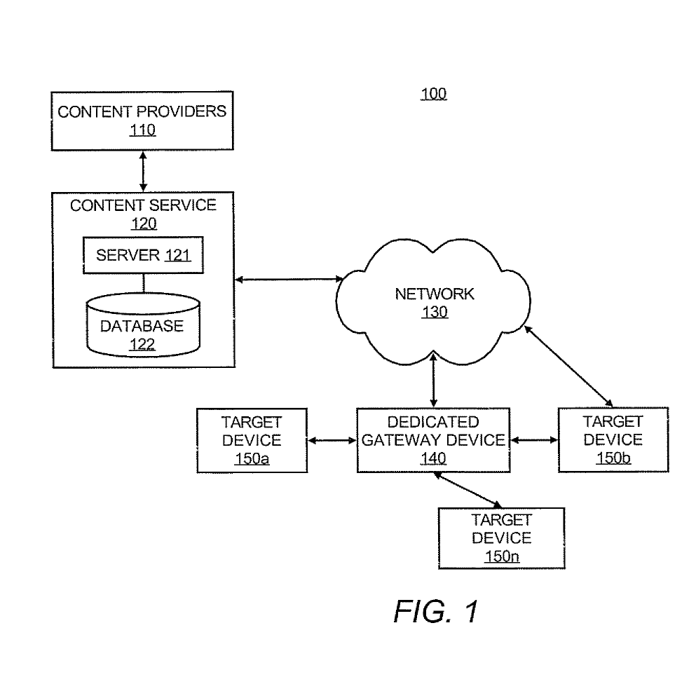

FIG. 1 illustrates a system 100 for content distribution according to an embodiment. The system 100 includes content providers 110, content service 120, network 130, a dedicated gateway device 140, and target devices 150a-n. Although only one dedicated gateway device 140 is shown in FIG. 1, it should be understood that more than one dedicated gateway devices may be used for content harvesting and harmonization with a plurality of target devices. The content providers 110 include entities configured to provide content that may be played or otherwise consumed by users. Content may include: media such as audio, video, text; multimedia that includes two or more of audio, video and text; or other types of data. Examples of content include but are not limited to media files, such as MP3 files, other types of audio files, video files, textual music play lists, and other types of files. Examples of content providers 110 include but are not limited to news providers (such as local and cable news television stations), television studios, movie studios, music labels, online music (or other media) providers, and others.

Generally speaking, the content providers 110 provide content to the content service 120, such that the content service 120 may provide several functions. One of the functions includes receiving new content from the content providers 110 on a substantially regular basis. Another of the functions includes making the content received from the content providers 110 available to users. In addition, the content service 120 may receive content from multiple content providers 110 to provide users with a relatively large content selection. Users may obtain the content made available by the content service 120 through, for instance, one or both of subscription services and on-demand services.

The content service 120 may also automatically organize content for users and continually provide new content to users. In addition, the content service 120 may perform other functions, such as billing, user information tracking, historical data tracking, etc. It will apparent to one of ordinary skill in the art that the content service 120 may represent multiple content services, each maintained or managed by a different entity or organization that provides such a service to the users, whereby such a entity or organization may or may not also be one of the content providers 110. Each content service 120 may include a server 121 and a database 122 for storing user information and content. The server 121 may facilitate the downloading of content to the target devices 150a-n used by the users. It will be apparent to one of ordinary skill in the art that the server 121 may include multiple servers and the database 122 may include multiple databases depending on the size and complexity of the content service 120. For example, to support a relatively large number of users, several servers 121 and databases 122 may be needed to harvest content from the content providers 110 and provide content to users with minimal delay.

The network 130 may represent one or more data networks. The network 130 may include one or more of private networks, public networks, such as the Internet, wireless networks, such as satellite and cellular networks, and local area wireless networks, such as Wi-Fi or Bluetooth networks, wired networks, local area networks, wide area networks, and any other type of communication network.

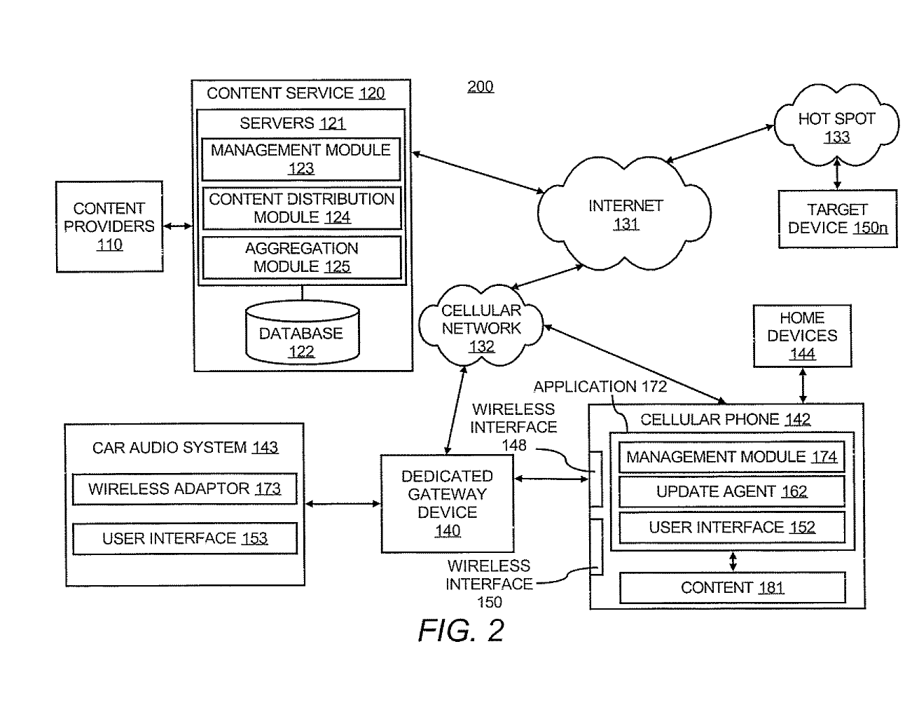

The content service 120 may provide content to the target devices 150a-n via the network 130 and the dedicated gateway device 140. Thus, a target device 150a may download the content from the content service 120 via the dedicated gateway device 140, which harvests content from the content service 120 and harmonizes and synchronizes with the target device 150a to download such content to the target device 150a. Alternatively, a target device, such as the target device 150b, may also download the content from the content service 120 without going through the dedicated gateway device 140. The content service 120 and target devices 150a-n are described in further detail with respect to FIG. 2. Examples of suitable target devices 150a-n include but are not limited to personal computers, personal digital assistants, wireless or cellular phones, car radio, home stereos, set-top boxes, MP3 players, portable video players, and other end-user devices.

2. Overview of Functionality and Advantages of Content Service

The system 100 provides a media experience for users without requiring a user to change conventional behavior to utilize the content service 120 providing the media experience. For example, the system 100 allows a user to play his or her selected audio content, such as music stations, talk radio, personal content, etc., on one of several target devices 150a-n that the user may be using at any particular time, such as a car radio in the car, a cellular phone when the user is on the go, a personal computer or home stereo at home. A target device may carry content selected by the user in a set of channels which are seamlessly available throughout the day on any one of many target devices. The system 100 manages the content and ensures the content is automatically replenished as it is consumed. Furthermore, an interface that is the same as or similar to a conventional device interface may be provided on the target devices 150a-n, so the user may play desired content on any target device in a relatively quick and easy manner.

According to an embodiment, the content service 120 allows a user to configure one or more sets of channels for one or more of the target devices 150a-n. Each channel is populated with content from a content provider or content provided by the user, referred to as the user's personal content. A channel is a data set of content, which may be of a particular type of content. For example, the content service 120 may make available hundreds of stations of content or individual pieces of content. Webcast radio and webcast television are some examples of stations of content. The content service 120 may provide one or more of the stations of content to users as a subscription service, where one or more stations are subscribed to by a user and the content for the stations is sent to one or more target devices for the user. In one example, one or more stations provide large or continuous blocks of Digital Millennium Copyright Act (DMCA) statutory license compliant streaming content. Some examples of individual pieces of content include single songs or albums, movies, video clips, etc. The content service 120 may provide an on-demand service where a user may purchase and download individual pieces of content.

Furthermore, channels may include content of a particular type, such as a sports talk channel, a popular music channel, etc. A user may configure a set of channels, hereinafter referred to as a channel set, for example, by selecting content provided by the content service 120 and of interest to the user. The channels may include high-quality, digital content, which may be commercial-free in some instances. A channel in a channel set may also include content from a user's personal collection, such as audio files stored on the user's personal computer. This channel may be programmed by play list, genre, or artist, or any other desired category or set of content.

A user may configure several channel sets, such that the user may use different channel sets at different times. For example, a user may create a first channel set for everyday use, such as for commuting to work. This channel set may include a traffic and news channel, a sports talk radio channel, as well as other channels. The user may create a second channel set for long trips, which may include, for instance, a classic rock channel and a comedy channel.

Content for the channels may be downloaded to one or more of the target devices 150a-n from the content service 120. The content service 120 may also refresh a target device with new content on a substantially continuous or periodic basis. For example, after content in a channel in a target device is consumed by a user, such as after the content is played, or after content becomes stale, such as after a predetermined period of time has lapsed, the content in the channel may be replenished or replaced with new content as received from the content service 120 or new content that was cached in the dedicated gateway device 140. This update of content on a target device may be performed automatically, and may be beneficial for target devices 150a-n that have limited storage for storing content, such as a PDA, phone, or other device having a relatively small amount of storage space.

In addition, the target devices 150a-n may each include an interface that is similar to or the same as a conventional user interface widely used in at least one type of today's end user devices. Thus, a user may not be required to learn how to use the interface of a target device. Furthermore, a common interface may be provided on several target devices 150a-n that may be used by a single user to play content. For example, the common interface may be provided on a user's phone, personal computer, car radio, etc. Thus, the user may not need to learn how to use different interfaces for different target devices 150a-n.

The user interfaces of the target devices 150a-n may emulate or include the user interfaces of conventional radio or music players with channel presets. The interfaces on the target devices 150a-n may provide for “one-click” channel selection, similar to clicking a channel preset button on a radio. In one example, each channel may include content populated with a type or genre of music pre-selected by the user, which allows a user to switch with one click between channels similar to switching between different radio stations on a radio. The interface may also allow a user to fast forward, rewind, or pause content.

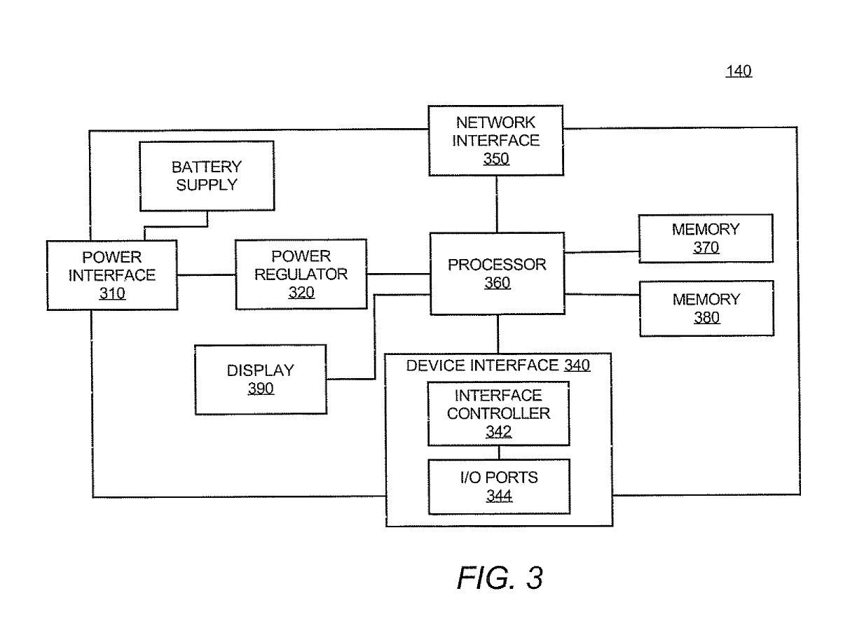

According to one embodiment, the dedicated gateway device 140 allows a user to manage and configure channel sets and update content on multiple target devices 150a-n. The gateway 140 is described in further details with respect to FIG. 3.

3. Content Service and Initialization of Dedicated Gateway Device

FIG. 2 illustrates an embodiment of the system 100 for content distribution. The content service 120 is shown as including a management module 123, a content distribution module 124, and an aggregation module 125, in addition to the server 121 and the database 122 discussed with respect to FIG. 1. As referred herein, a module includes one or more software programs, applications, or routines stored on a computer readable medium (CRM) for execution by at least one processor. Embodiments of a CRM include but are not limited to an electronic, optical, magnetic, or other storage or transmission device capable of providing a processor in the receiver with computer-readable instructions. Other examples of a suitable CRM include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a processor may read instructions. In addition, or alternatively, a module may refer to hardware configured to perform one or more functions described herein.

The management module 123 may coordinate information between multiple users. For example, the management module 123 may receive channel configuration information from multiple users, which may include user selections of content for channels in one or more sets of channels for the multiple users. The user selections and channel sets configured by the users may be stored in the database 122 along with additional channel configuration information added by the content service 120, such as permissions and special attributes or rules for content consumption, that is related to the user selections and configurations. The database 122 is queried subsequently to determine the content to provide to the users. In one embodiment, the management module 123 generates a web based user interface which allows a user to log into the content service 120, register with the content service 120 and set preferences, and configure channel sets.

In one embodiment for initializing the dedicated gateway device 140, a user connects to the content service 120 via the network 130 shown in FIG. 1, which may include the Internet 131 and/or other networks shown in FIG. 2, using a personal computer. The user provides user information to the content service 120, which is stored in the database 122. The user information may include an identification (e.g., serial number) of the particular dedicated gateway device 140 that the user intends to use for harvesting content from the content service 120 and harmonizing such content with one or more target devices 150a-n. During the initialization or set-up of the dedicated gateway device 140, the management module 123 may prompt a user for channel configuration information, such as a selection of a content type for each channel. Examples of content that may be selected for a channel set may include genre-oriented music stations, talk content, the user's personal content, etc. Genre-oriented music content may be selected from a catalog listing a relatively large number of stations or individual content provided by the content providers 110. In addition, a single music channel may deliver a continuous set of music tracks on a target device. Talk content may also be selected from a catalog of talk content channels, which may be updated periodically, such as hourly, daily or weekly. In addition, content from more than one content provider may be placed in a single channel set. The user's personal content may be stored on the dedicated gateway device 140, which the management module 123 may discover. As such, a user may sort through various content in various manners and may move individual tracks of content or large blocks of content to a channel in a channel set.

Accordingly, for example, the user may select news, traffic, and weather for channel 1, sports talk radio for channel 2, pop music for channel 3, alternative music for channel 4, classic rock music for channel 5, and classical music for channel 6. The management module 123 stores the user selections in the database 122, and channels 1-6 are populated with content corresponding to the associated user selections, and related channel configuration information added by the content service 120, using the content distribution module 124. It should be readily understood that six channels have been described above for purposes of illustration and not of limitation. Therefore, any reasonably suitable number of channels may be available for configuration without departing from the scope of the system 100.

Alternatively, the management module 123 may prompt the user for user information, and channels may be selected for the user based on the user information. Then, such channel selection information may be sent to the user either directly or through the dedicated gateway device 140. For example, the user may provide demographic information or a selection of favorite artists. Several channels may be selected for a channel set for the user based on this information. The user may select some of the channels for a channel set. Default channels may also be provided. Also, several channel sets may be configured for each user.

In another embodiment for initializing the dedicated gateway device 140, the user may gain access to the dedicated gateway device 140 through connection having a user interface, such as a phone or a personal computer. The user then uses such a user interface to input authentication information (e.g., a number code or password) that was previously provided by the content service 120 in order to initialize the dedicated gateway device 140.

The content distribution module 124 sends content for channel sets to one or more target devices 150a-n via the dedicated gateway device 140. Thus, once the dedicated gateway device 140 is set up or initialized by the user, it may be connected to the network 130 to automatically harvest from the database 122 the content based on the channel content configuration previously entered by the user and stored in the management 123—all without any further intervention from the user. The harvested content then may be cached in the dedicated gateway device 140 for future downloading or harmonization with one or more target devices 150a-n. Thus, the dedicated gateway device 140 provides a simple and straightforward solution for harmonizing target devices 150a-n without using a personal computer with dedicated, OS-specific gateway application software installed therein. Additional, the dedicated gateway device 140 may be used anywhere there is an open, functional connection to the network 130 without any further need to install the dedicated, OS-specific gateway application software at each new location. The content distribution module 124 may determine the content to send to the dedicated gateway device 140 based on the related channel configuration information. For example, the content distribution module 124 retrieves channel configuration information for a selected set of channels from the database 122. In addition, the content distribution module 124 may send content for the respective channels to the dedicated gateway device 140 for downloading to one or more target devices 150a-n.

The aggregation module 125 receives, for example, content and play lists from the content providers 110 and stores the information in the database 122, such that the content may be distributed to users as needed.

4. Dedicated Gateway Device

FIG. 3 illustrates the dedicated gateway device 140, in accordance with one embodiment of the present invention. The dedicated gateway device 140 includes a power interface 310, a power regulator 320, an optional battery supply 330, a device interface 340, a network interface 350, a processor or processing unit 360, a first memory 370 for storing operating code of the processing unit 360, and a second memory 380 for storing a gateway application and content harvested from the content service 120.

The power interface 310 provides external power to the dedicated gateway device 140. For example, the power interface 310 may be a power input jack, such as a 5-volt input jack, that receives power from an external power supply. The input power is then fed to a power regulator 320, such as a voltage regulator, to ensure a constant voltage level is received by the dedicated gateway device 140. In lieu of or in addition to the power interface 310, there is provided an internal battery supply 330 for providing power to the dedicated gateway device 140 when the external power supply is inadequate or not available. The processing unit 360 represents one or more processors, such as microprocessors, for controlling operations of the dedicated gateway device 140. The processing unit 360 executes programming code, such as firmware, stored in the first memory 370 for operating the dedicated gateway device 140. Any suitable CRM, such as a flash Read-Only-Memory (ROM) chip, may be used to implement the first memory 370. In an alternative embodiment, the first memory 370 may be embedded or included in the processing unit 360.

The processing unit 360 also executes programming code stored in the first memory 370 for a gateway application to harvest content from the content service 120 and to harmonize with a target device 150a connected to the dedicated gateway device 140. The second memory 380 is also used to cache or store content harvested from the content service 120. As noted earlier, because the gateway device 140 is dedicated to harvesting content and harmonizing a connected target device 150a with the harvested content, a low-cost processing unit 360 with lower processing power may be implemented in the gateway device 140 because such a processing unit is not taxed with running other applications, as with a typical central processing unit (CPU) in a convention PC. The gateway application residing in the second memory 380 may include an update agent or component that generally receives content from the content service 120 and refreshes the content stored in the dedicated gateway device 140 on a periodic basis. For instance, the update agent caches content in the second memory 380 of the dedicated gateway device 140. The cached content may include content received from the content distribution module 124 of the content service 120. In one embodiment, the transfer of content from the content distribution module 124 of the content service 120 to the dedicated gateway device 140 may be performed as a substantially automatic feature when the dedicated gateway device 140 is connected to the content service 120 via the network 130, whereby the user does not need to issue a transfer command. The update agent may control the transfer of content to the dedicated gateway device 140 such that new content may be cached in the dedicated gateway device 140 from one or more playlists. In addition, the update agent may control the harvesting of content to generally enable the new content to be stored on the dedicated gateway device 140 while staying within the limitations of the storage capabilities of the dedicated gateway device 140 and meeting the limitations of the storage capabilities of the target devices 150a-n connected thereto.

As with the first memory 370, any suitable CRM may be used to implement the second memory 380. Alternative embodiments are contemplated wherein the first memory 370 and the second memory 380 may be implemented in the same CRM, or each may be implemented in one or more CRM. The second memory 380 may have any desired storage capacity. For example, the second memory 380 has the same memory storage capacity as any one of the target devices 150a-n, or one with the largest memory storage capacity, in order to store sufficient content for downloading to the target devices. In another example, the second memory 380 has more memory storage capacity than that of any of the target devices 150a-n for redundancy or accommodation of future target devices that will have more memory storage capacity. Furthermore, the second memory 380 may be removable from the dedicated gateway device 140 so that different memory sizes may be swapped for insertion into the dedicated gateway device 140.

The device interface 340 provides a connection to one or more target devices 150a-n. In one embodiment, the device interface 340 includes one or more input/output (I/O) ports 344, e.g. one or more Universal Serial Bus (USB) ports, and a device interface controller 342, such as a USB host, for controlling the I/O ports 342 and allowing the connection of one or more target devices 150a-n to the dedicated gateway device 140. In one embodiment, one or more of the USB ports may also be used to provide content storage through a connected USB storage device (e.g., any CRM with a USB connection) in addition to or in lieu of the available second memory 380. The device interface 340 also may act as a power charging station to charge power to a connected target device. Alternative embodiments are contemplated wherein the device interface 340 is a wireless interface that provides one or more target devices 150a-n with wireless connection to the dedicated gateway device 140. Examples of a wireless connection include but are not limited Bluetooth (IEEE 802.15 specification) and Wi-Fi (IEEE 802.11 specification).

The network interface 350 provides the dedicated gateway device 140 with a connection to the network 130, such as the Internet 13 1, for harvesting content from the content service 120. In one embodiment, the network interface 350 provides an Ethernet connection, with an Ethernet port, to the Internet 131. In another embodiment, the network interface 350 is a wireless interface that wirelessly connects to the Internet 131, via an available wireless router and host such as a Wi-Fi hotspot. The network interface 350 also may provide power to the dedicated gateway device 140 in addition to or in lieu of the power interface 310 and the battery supply 330.

The dedicated gateway device 140 may also have a simplified user interface that includes a reset mechanism, such as a reset button, and one or more visual indicators or displays 390, such as light emitting diodes (LEDs), to indicate the status of the dedicated gateway device 140. The reset button may be used to reset the dedicated gateway device 140 in cases where the dedicated gateway device 140 becomes non-responsive when connected to the network 130 for content harvesting, when connected to a target device 150a for content harmonization, or both. A reset allows the dedicated gateway device 140 to restart whatever process it was running prior to “freezing up” or becoming non-responsive. Examples of status LEDs include but are not limited to any combination of: a LED for indicating that a proper connection has been made between the content service 120 and the dedicated gateway device 140, a LED for indicating that content harvesting is in progress (i.e., content is being harvested from the content service 120 and cached in the dedicated gateway device 140), a LED for indicating that a proper connection has been made between the dedicated gateway device 140 and a target device 150a, and a LED for indicating that content harmonization is in progress with a connected target device 150,

According to one embodiment of the present invention, the content storage functionality of the dedicated gateway device 140 may be transferred to an external device, such as a nearby PC or another dedicated gateway device, to which the dedicated gateway device 140 may be wired or wirelessly connected via the device interface 340. Thus, any harvested content is transferred to the external device by the gateway application running in the dedicated gateway device 140.

5. Portable Content Device

One of the target devices 150a-n may be a portable content device, such as the cellular phone 142, PDA, MP3 player, and the like, may include an application 172 having a management module 174, an update agent 162, and a user interface 152. The management module 174 generally allows the user to determine and send and receive channel configuration information for configuring selected channel sets to the content service 120, in manners similar to those described above with respect to the management module 123 of the server 121. In certain instances, the management module 174 may be considered optional for the application 172 because management of the application 172 may be performed by dedicated gateway device 140.

The update agent 162 of the cellular phone 142 generally controls updating of the content 181, which may include new content received from the content service 120 via the cellular network 132, the Internet 131, a wireless proximity network such as Bluetooth or Wi-Fi (802.11) as further discussed later, or any combination thereof, as routed from the content service 120 or through the dedicated gateway device 140. For example, the content 181 may comprise new cached content as received from the content service 120 as routed through the Internet 131 and cellular network 132, as shown in FIG. 2. In another example, the content 181 may comprise new cached content received from the dedicated gateway device 140 via a wired connection or a wireless proximity network.

The update agent 162 of the cellular phone 142 may also manage the receipt of content from one or both of the content service 120 and the dedicated gateway device 140. More particularly, for instance, the update agent 162 may control the receipt of one type of content from the content service 120 and another type of content from the dedicated gateway device 140. For example, the update agent 162 may control the receipt of content, such that, content required to be updated relatively frequently (hot content), such as traffic information, is received from the cellular network 132. In another example, the update agent 162 may control the receipt of content such that hot content is received from the dedicated gateway device 140 before such content expires (without going through the cellular network 132 or any other wireless telecommunication network). In addition, the update agent 162 may control the receipt of cold content, which are content that may be updated less frequently, to be received from the dedicated gateway device 140. In this example, the dedicated gateway device 140 may download the cold content from the content service 120. Furthermore, when the cellular phone 142 is connected to or otherwise interfaces with the dedicated gateway device 140, the cold content may be updated on the cellular phone 142. It will be apparent to one of ordinary skill in the art that cold content, such as music, may also be downloaded to the cellular phone 142 via the cellular network 132.

As shown in FIG. 2, the cellular phone 142 is also depicted as including a wireless interface 148, which may be used to connect to the content service 120 via hot spots 133, to the dedicated gateway device 140, to other target devices 150a-n, to a home device 144, etc. to receive content for playback. The cellular phone 142 further includes a wireless interface 150, which may be used to transfer content 181 to the car audio system 143 via the wireless adaptor 173. The car audio system 143 may include a user interface 153 to allow users to control its operations. Alternatively, the wireless interfaces 148 and 150 may combine as a single wireless interface that performs all functions of the wireless interfaces 148 and 150.

Playback of the content 181 may be controlled via the user interface 152 of the cellular phone 142. For example, the user interface 152 may include controls to enable the selection of a preset channel, to rewind, fast forward, pause, play, etc.

Although not shown, the cellular phone 142 may comprise a device configured to provide the functionalities of multiple devices. For example, the cellular phone 142 may include an MP3 player, PDA, camera, video player, etc.

The dedicated gateway device 140 is operable to first harvest and cache content from the content service 120 and then harmonize such content with a connected target device 150. Alternatively or in addition, the dedicated gateway device 140 is operable to concurrently harvest the content and harmonize with a connected target device to download the harvested content from the content service 120 directly to the target device 150.

6. Methodology

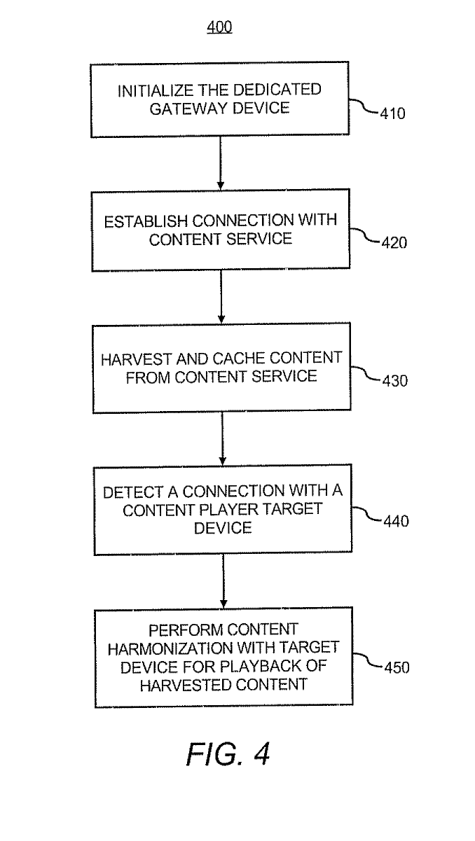

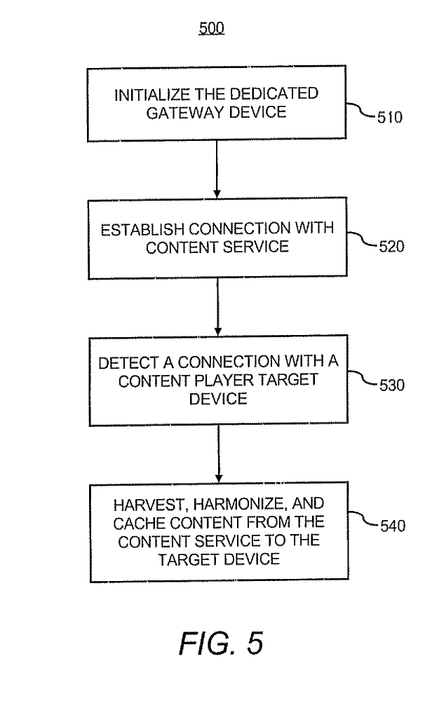

FIGS. 4-5 illustrate various methods for using a dedicated gateway device to harvest and download content from a content provider to a target device connected thereto, such as a portable content player, in accordance with various embodiments of the present invention. These methods are described with respect to FIGS. 1-3 by way of example and not of limitation. Thus, it will be apparent to one of ordinary skill in the art that these methods may be performed with systems and devices other than those depicted in FIGS. 1-3.

Referring to FIG. 4 and the method 400 therein, at 410, the dedicated gateway device 140 is set-up or initialized to authenticate the dedicated gateway device 140 and enable a connection to the content service 120 for content harvesting. This initialization may be prompted by the user as described earlier.

At 420, subsequent to the initialization, the dedicated gateway device 140 establishes a connection with the content service 120 via the network 130. This connection may be prompted by the user providing a connection between the dedicated gateway device 140 and network 130, whereby the dedicated gateway device 140 automatically seeks out the content service 120 over the network 130 for authentication and connection.

At 430, once the dedicated gateway device 140 is properly connected to the content service 120, it begins harvesting and caching content from the content service 120 in accordance with the initialization, for example, in accordance with the channel configuration information provided by the user and stored at the content service 120. As noted earlier, the harvested content maybe cached in an internal memory, such as the second memory 380, or in an external memory, as wired or wirelessly connected to the dedicated gateway device 140 via one or more of the I/O ports in the device interface 340. Once the dedicated gateway device 140 has completed harvesting and caching the content, it may be disconnected from the content service 120.

At 440, the dedicated gateway device 140 detects a connection with a target device 150. This notification may be automatically detected upon a connection of the target device 150 to one of the I/O ports in the device interface 340.

At 450, the dedicated gateway device 140 harmonizes its cached content with the content in the connected target device 150 so that the target device 150 has updated content for playback of the harvested content. At this juncture, the dedicated gateway device 140 is no longer connected to the content service 120.

FIG. 5 illustrates an alternative method 500 for using a dedicated gateway device to harvest and download content from a content provider to a target device connected thereto, such as a portable content player. The method 500 at 510 and 520 is similar to the method 400 at 410 and 420, respectively. However, at 530, the dedicated gateway device 140 detects a connection with a target device 150. This notification may be automatically detected upon a connection of the target device 150 to one of the I/O ports in the device interface 340. Then at 540, once the dedicated gateway device 140 is properly connected to the content service 120 and the target device 150, it begins harvesting, harmonizing, and caching content from the content service 120 directly to the target device 140 connected thereto without first caching the content in the dedicated gateway device 140. Alternatively, the dedicated gateway device 140 also caches the harvested content for future re-harmonization with the target device 150, for example, in case when the content stored in the target device 150 becomes corrupted and needs to be reloaded.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A gateway device dedicated for harvesting content from a content service and harmonizing the content with a content player, comprising:
a first interface operable to be connected to the content service to harvest content from the content service;
a first memory storage operable to store the harvested content; and
a second interface operable to be connected to a content player for harmonizing with the content player so as to ensure that the stored content is available in the content player for content playback.

2. The dedicated gateway device of claim 1, further comprising:
a reset mechanism operable to reset the dedicated device by stopping one of content harvesting and content harmonization.

3. The dedicated gateway device of claim 1, further comprising:
at least one visual indicator for indicating one of a proper connection with the content service, content harvesting is in progress, a proper connection with the content player, and content harmonization with the content player is in progress.

4. The dedicated gateway device of claim 1, further comprising:
a second memory storage operable to also store the harvested content, the second memory storage is accessible by the dedicated gateway device via the second interface.

5. The dedicated gateway device of claim 4, wherein the second interface is a wireless interface.

6. The dedicated gateway device of claim 1, wherein the second interface is operable to provide a wireless connection to the content player.

7. The dedicated gateway device of claim 1, wherein the first interface is operable to be connected to the content service via a wireless connection to a data network.

8. The dedicated gateway device of claim 1, further comprising:
a third interface operable to be connected to one of an external power supply and an internal power supply for providing power to the dedicated gateway device.

9. The dedicated gateway device of claim 1, further comprising:
a processing unit operable to control operations of the first interface, the first memory storage, and the second interface.

11. A method for employing a dedicated gateway device to harvest and harmonize content with a content player, comprising:
initializing the dedicated gateway device for harvesting content;
establishing a connection between the dedicated gateway device and a content service to harvest content from the content service based on the initializing;
the dedicated gateway device harvesting the content from the content service, the content is selected from the initializing;
the dedicated gateway device detecting a connection with the content player; and
the dedicated gateway device harmonizing with the content player to ensure that the harvested content is available in the content player for playback.

12. The method of claim 11, further comprising:
the dedicated gateway device caching the harvested content in one of an external memory and an internal memory for the harmonizing with the content player.

13. The method of claim 11, wherein the dedicated gateway device harmonizing with the content player comprises:
the dedicated gateway device caching at least some of the content in the content player as it is being harvested by the dedicated gateway device.

14. The method of claim 11, wherein establishing the connection between the dedicated gateway device and the content service comprises:
establishing the connection as a wireless connection.

15. The method of claim 11, wherein dedicated gateway device detecting the connection with the content player comprises:
the dedicated gateway device detecting the connection as a wireless connection.

16. The dedicated gateway device of claim 1, wherein the first interface is operable to be connected to the content service to receive content configuration information for sending to the content player.

17. The dedicated gateway device of claim 1, wherein the second interface is operable to be connected to the content player to receive content configuration information for sending to the content service.

18. The method of claim 11, further comprising at least one of:
sending content configuration information to the content player; and
receiving content configuration information from the content player.

19. A computer readable medium on which is encoded program code for employing a dedicated gateway device to harvest and harmonize content with a content player, the program code comprising:
program code for initializing the dedicated gateway device for harvesting content;
program code for establishing a connection between the dedicated gateway device and a content service to harvest content from the content service based on the initializing;
program code for harvesting with the dedicated gateway device the content from the content service, the content is selected from the initializing;
program code for detecting with the dedicated gateway device a connection with the content player; and
program code for harmonizing the dedicated gateway device with the content player to ensure that the harvested content is available in the content player for playback.

20. The computer-readable medium of claim 19, further comprising:
program code for caching in the dedicated gateway device the harvested content in one of an external memory and an internal memory for the harmonizing with the content player.

21. The computer-readable medium of claim 19, wherein the program code for harmonizing comprises:
program code for caching in the dedicated gateway device at least some of the content in the content player as it is being harvested by the dedicated gateway device.

22. The computer-readable medium of claim 11, wherein the program code for establishing the connection between the dedicated gateway device and the content service comprises:
program code for establishing the connection as a wireless connection.

23. The computer-readable medium of claim 11, wherein the program code for detecting comprises:
program code for detecting with the dedicated gateway device the connection as a wireless connection.
